(19) United States
(12) Patent Application Publication
(10) Pub. No.: US 2014/0131613 A1
(43) Pub. Date: May 15, 2014

(54) REFRIGERANTS

(71) Applicants: Anatoly Vishnevsky, Haifa (IL); Alexander Ignatovski, Haifa (IL); Yuri Belilovski, Kiriat Bialik (IL)

(72) Inventors: Anatoly Vishnevsky, Haifa (IL); Alexander Ignatovski, Haifa (IL); Yuri Belilovski, Kiriat Bialik (IL)

(73) Assignee: Galkor Energy Systems Ltd.

(21) Appl. No.: 13/674,181

(22) Filed: Nov. 12, 2012

(51) Int. Cl. C09K 5/04

(52) U.S. Cl. CPC C09K 5/042
USPC 252/67

(57) ABSTRACT

Refrigerants for use in a thermodynamic cycle taking place in a system producing either hot or cold are disclosed. The refrigerants comprise binary azeotrope mixture of saturated hydrocarbon with either methanol or ethanol. The refrigerants are of preventing undesirable formation of oil film on the inner surface of the circulating system and thus to improve the performance of the system.

### FIELD OF THE INVENTION

The present invention relates primarily to refrigerants used in the field of air conditioning, and also relates to refrigerants used in other domestic and industrial applications, wherein either cold or heat is produced by effecting a thermodynamic cycle.

### BACKGROUND OF THE INVENTION

Traditionally, fluorocarbons, especially chlorofluorocarbons, have been used as refrigerants. However, such refrigerants are being phased out because of their ozone depletion effects. Other common refrigerants used in various applications are: ammonia, sulfur dioxide, and non-halogenated hydrocarbons such as propane. Many of such refrigerants are being known as important ozone depleting and global warming inducing compounds. Accordingly, these refrigerants have been the focus of a worldwide regulatory scrutiny, resulted in their use restrictions.

The present invention concerns new and improved refrigerants based on natural hydrocarbons, which are environmentally friendly. In particular the present invention refers to such natural hydrocarbons like propane and isobutane, which in combination with alcohols and other organic compounds are capable of forming binary azeotrope mixtures.

For the purposes of the invention, the term “azeotrope” is considered to be a mixture having a composition which cannot be changed by simple distillation. This is because, when an azeotrope is boiled, the vapor it produces has proportionate constituents as the original mixture.

In view of the fact that composition can not be changed by distillation, azeotropes are also called constant boiling mixtures. The word “azeotrope” is derived from combination of two Greek words “boil” and “state” combined with the prefix a- (no) to give the overall meaning, “no change on boiling”.

In a thermodynamic vapor/compression cycle that is carried out in an air conditioning system usually refrigeration lubricants are employed, which lubricate rubbing parts of the compressor to reduce friction between the parts and thus to increase their service life. Basically, these lubricants constitute a mixture of organic oil compounds and can be either mineral, i.e. natural oils or synthetic oils. Among the synthetic based oils are for example, polyol ester, polyalkylen glycols, alkylbenzenes, polyalpholefines.

Unfortunately irrespective of the oil type the refrigerant lubricants unavoidably enter in the tubes of the refrigerator circulation system, adhere to inside surface of the tubes and deposit thereon in the form of an oil film. Since the oil film has high thermal resistance, its formation causes reduction of the total heat exchange efficiency of the circulation system. Eventually, formation of such oil films results in the reduced coefficient of performance.

Therefore, to improve the coefficient of performance, it should be desirable to eliminate, or at least partially to reduce, formation of the oil film within the tubes of the refrigerant circulation system. This should occur however, without compromising the other positive properties of natural hydrocarbon refrigerants, such as for example their Ozone Depletion Potential (ODP) and Global Warming Potential (GWP)-coefficient. Furthermore, it should be desirable to dissolve oil films formed by any type of the oil employed in the system.

There are known attempts in the prior art to resolve the above-discussed problems.

For example, U.S. Pat. No. 4,963,280 discloses admixing polar substances to the oil, which cause dissolution of the oil. Among suitable additives are mentioned chlorinate a-olefin or chlorinate paraffin. These substances however, are ecologically harmful and also cause foaming of the oil. Furthermore an expensive device is required for evacuation of the oil dissolution products.

In U.S. Pat. No. 6,669,862, it is suggested to use a refrigerant, having a composition containing at least one component capable to dissolve the oil. In particular for a refrigerant constituting a mixture of three commercially available hydrofluorocarbons R32, R125 and R134a it is suggested to admix up to 1.5% of lower alkyl alcohols, such like methanol and ethanol as well as not more than 4% of propane or isobutane. Unfortunately, such a refrigerant mixture has low chemical stability, high glide factor and besides high ODP and GWP coefficient, which renders it less attractive for use.

In Chinese Patent Application 21010148129, it is described hydrocarbon refrigerant, which is a mixture containing 90-96% of propane, 2-7% of isobutane, 1.5-2.8% of alcohol fatty oil and 0.2-0.5% of ethanol. This composition has several disadvantages. Since ethanol has a relatively high boiling point, it does not vapor during the working cycle and accordingly does not contribute to the energy transfer from a low level to a high level. Ethanol can work in a cycle merely when it is mixed with a low boiling azeotrope, i.e. with isobutane, since ethanol does not form azeotropic mixture with propane. The content of ethanol in isobutane azeotrope is not more than 0.9%, when it is calculated for the whole mass of the refrigerant. Even in the refrigerant containing maximum concentration of isobutane, which is 7%, the ethanol concentration is not more than 0.005%. This low content of ethanol in the azeotrope would be insufficient for dissolution of the oil foil. To achieve the oil dissolution, the refrigerant composition contains alcohol fatty oil, which brings to undesirable foaming of the oil and forms dissolution products, which require evacuation.

Thus it should be obvious that in spite of the attempts to provide some refrigerants with ability to dissolve oil film within a refrigerant circulation system, no effective solution of this problem has been achieved.

The present invention in particular concerns with binary azeotropic refrigerants intended for substitution of such commercially available refrigerants as liquefied propane and isobutane, known under designation R290 and R600a, according to American Society for Heating and Refrigeration and Air Conditioning Engineers (ASHRAE).

While the refrigerants of the present invention have similar advantages to that of R290 and R600a, in terms of zero ODP and very low GWP, high coefficient of performance (COP), high energy efficiency ratio (EER), the present refrigerants have nevertheless additional advantages related to improved efficiency and reduced flammability.

Explanation and calculation of Global Warming Potential can be found elsewhere, e.g. in the Internet site http://eeocw.org/get-involved/global-warming-potential.

### SUMMARY OF THE INVENTION

In the invention, the term “refrigerant” is considered to be a substance used in a thermodynamic cycle in which a reversible phase transition of the refrigerant from a liquid to a gas is exploited and by virtue of this phase transition either heat or cold is produced.

The refrigerants of the invention can be used in air conditioners, heat pumps, refrigeration systems and other industrial and domestic installations for heating or cooling of various mediums.

The present invention is also suitable for the so called Organic Rankine cycle (ORC) for producing of heat. In this application the refrigerants of the invention is used as working fluids for effecting heat recovery from lower temperature sources like biomass combustion, industrial waste heat, geothermal heat, solar ponds, etc. The produced heat can be then converted into mechanical energy.

An essential object of this invention is to provide new and improved refrigerants, which are capable of dissolving the refrigerant lubricants, so as to at least partially prevent formation of an oil film on the inside surface of a refrigerant circulation system.

A further object of the invention, is to provide new and improved refrigerants, capable of dissolving the refrigerant lubricants irrespective of whether the refrigerants are present in the circulation system as a gas or as a liquid.

A still further object of the invention is to provide new and improved refrigerants, which upon dissolution of the lubricants are capable of efficient vaporization, so as to allow efficient and convenient evacuation of the refrigerants from the carter of the circulation system and their subsequent regeneration.

Another object of the invention, is to provide new and improved refrigerants, which do not cause foaming of the lubricants.

Yet another object of the invention, is to provide new and improved refrigerants, which are based on natural hydrocarbons, environmentally friendly, have low glide factor and low flammability, the refrigerants which are chemically inert with respect to the lubricants and are non toxic.

Still further object of the invention is to provide new and improved refrigerants, which are inexpensive and could be easily produced from available natural or synthetic hydrocarbon raw materials.

Yet further, the object of the present invention is to provide new and improved refrigerants enabling sufficiently reduce or overcome the above-mentioned drawbacks of the known in the art refrigerant

In accordance with the invention the above and other objects and advantages can be achieved with refrigerants consisting at least of a combination of the following two components:
1) saturated hydrocarbon having carbon chain with 2 or 3 atoms of carbon,
2) aliphatic alcohol selected from a group including methanol and ethanol.

In accordance with the invention the above listed components should be capable to form a first azeotrope mixture, consisting of the saturated hydrocarbon and the aliphatic alcohol. The refrigerants consisting of the above combination of hydrocarbon and the aliphatic alcohol are suitable for polyol ester based oils, polyalkylen glycols based oils.

According to one embodiment of the invention the refrigerants composition may include also a third component, which is an auxiliary additive, selected from a group of substances including acetone, cyclopentane, cyclohexane, n-pentane, n-hexane, i-pentane and i-hexane.

The auxiliary additive should be capable to form a second azeotrope mixture, consisting of the aliphatic alcohol and the auxiliary additive.

According to the invention the refrigerants consisting of a combination of the above three components should be suitable for dissolving mineral oils, alkylbenzene based oils and polyalphaolefin based oils.

In practice the saturated hydrocarbon is either propane or isobutane.

According to another embodiment of the invention the above mentioned two components are selected in such a manner that there is provided a first refrigerant, consisting of combination of propane and methanol, a second refrigerant, consisting of combination of isobutane and methanol and a third refrigerant, consisting of combination of isobutane and ethanol.

According to still further embodiment the above three combinations may include also the auxiliary additive.

Accordingly, the first azeotrope mixture consists either of combination of methanol and propane, or combination of methanol and isobutane, or combination of ethanol and isobutane. The second azeotrope mixture consists either of combination of methanol and auxiliary additive or combination of ethanol and auxiliary additive.

In practice the content of the aliphatic alcohol within refrigerant, which is based on the first azeotrope mixture is 1.2-7.0 weight % for combination of methanol and propane, 3.0-8.0 weight % for combination of methanol and isobutane and 0.4-0.5 weight % for combination of ethanol and isobutane.

In practice the content of the aliphatic alcohol within refrigerant, which is based on the second azeotrope mixture is 4-38 weight % for combination of methanol and auxiliary additive, 4-31 weight % for combination of ethanol and auxiliary additive. For better understanding of the present invention as well of its advantages, reference will now be made to the following description of its various embodiments with reference to the accompanying drawings.

### BRIEF DESCRIPTION OF THE DRAWINGS

FIG. 1 shows schematically formation of oil deposits on the inside surface of tubes of a refrigeration system, when the system employs either conventional refrigerants (case I) or the refrigerants of the present invention (case II); and

FIG. 2 shows schematically an experimental setup for studying properties of new refrigerants of the present invention.

### DETAILED DESCRIPTION OF THE INVENTION

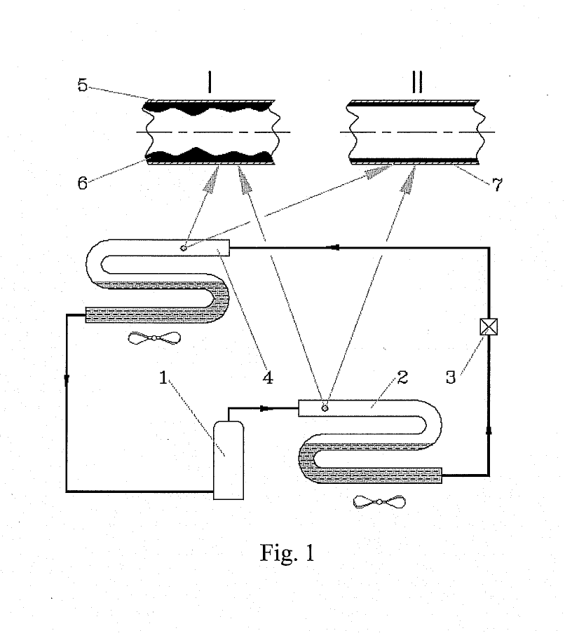

With reference to FIG. 1, it is presented in a very simplified manner, a cooling system used for example, for air conditioning employing either conventional refrigerant or refrigerant of the present invention. The system comprises the following basic components: a compressor 1, a condenser 2, an expansion device (capillary) 3 and an evaporator 4. It is not shown in details, but should be appreciated that both condenser and evaporator are provided with a plurality of tubes, through which the refrigerant circulates. The rubbing parts of the compressor are lubricated by oils. Some amount of the oil in the form of suspension, is forcibly taken out from the compressor, taken out by the circulating refrigerant and is carried out further into the condenser and then into the evaporator.

The oil suspension deposits on the inner surface of the tubes and forms thereon an oil film, which deteriorates the heat transfer and reduces the efficiency of the cooling system. It is shown in FIG. 1 an enlarged fragment of a tube 5 with deposits of an oil film layer 6, coating the inwardly facing surface of the tube. This situation is designated by the roman number I and it refers to a case, when conventional refrigerant circulates in the system. In accordance with the invention the composition of the refrigerant is selected in such a manner that the oil film is dissolved by the refrigerant and therefore the oil suspension does not adhere to the inwardly facing surface of the tubes and therefore no oil sediments deposit thereon. This situation is designated by the roman number II and it is shown that oil deposits are not present on the inside surface of a tube 7.

According to an essential aspect of the present invention, refrigerants are used having compositions comprising natural hydrocarbons, namely propane and isobutane as well as additives of substances capable to dissolve particular lubricant, employed in a cooling system, while the lubricant dissolution would take place irrespective of the lubricant type and irrespective of physical state of the refrigerant.

Among suitable dissolution additives are aliphatic alcohols, namely methanol or ethanol and some auxiliary additives, selected from the group consisting of acetone, cyclopentane, cyclohexane, n-pentane, i-pentane, n-hexane and i-hexane.

In practice the composition is selected according to the type of lubricant, which should be dissolved. For example, for dissolving polyol ester based oils as well as polyalkylen glycole based oils a combination of natural hydrocarbon and the aliphatic alcohol should be suitable. In particular, possible combinations can be propane with methanol, isobutane with methanol and isobutane with ethanol. In the above combinations, the aliphatic alcohol component should be responsible for the oil dissolution and the hydrocarbon component should be responsible for a thermodynamic functioning as a refrigerant. In order to based on a precondition that the components should be capable to form an azeotrope mixture having boiling point very close to the boiling point of a hydrocarbon, if it should be present in the refrigerant alone. By virtue of this provision, the refrigerants of the invention are defined by a very low glide factor.

In practice the content of aliphatic alcohol in the refrigerant composition should be kept as follows: 1.2-7.0 weight % for the azeotrope mixture of methanol and propane, 3.0-8.0 weight % for the azeotrope mixture of methanol and isobutane and 0.5-4.0 weight % for the azeotrope mixture of ethanol and isobutane.

It should be mentioned that the above-discussed aliphatic alcohols are selected also due to the following reasons.

The aliphatic alcohols are environmentally friendly similarly to propane and isobutane, do not chemically react with the lubricating oils, neither with propane or isobutane, the alcohols are thermally stable, have low viscosity and high thermal conductivity, and do not cause foaming of the lubricant oils. Furthermore, the use of methanol and ethanol in combination with propane and isobutane prevents formation of crystallohydrates between molecules of water and hydrocarbons and this reduces the danger of plugging-up of the tubes of the circulation system. In view of the above, the refrigerants of the present invention have reduced flammability.

Unfortunately, not all lubricant oils are soluble within the aliphatic alcohols. Therefore, in accordance with the invention it is suggested that the refrigerant composition should include auxiliary additives capable to dissolve those lubricant oils, which can not be dissolved by methanol or ethanol. Furthermore those auxiliary additives should be capable of forming azeotrope mixtures with the aliphatic alcohols. Thus, the alcohol's boiling should be reduced, thus simplifying alcohol's vaporization and further regeneration thereof. The particular list of substances, which can be used as a suitable auxiliary additive, will be provided later. Therefore, in the embodiments where the refrigerant composition comprises also the auxiliary additive the refrigerant should comprise two azeotrope mixtures.

In particular the following combinations are possible:

a) Refrigerant consisting of azeotrope mixture of propane with methanol and azeotrope mixture of methanol with auxiliary additive.

b) Refrigerant consisting of azeotrope mixture of isobutane with methanol and azeotrope mixture of methanol with auxiliary additive.

c) Refrigerant consisting of azeotrope mixture of isobutane with ethanol and azeotrope mixture of ethanol with auxiliary additive.

Among the substance, which could be used as suitable auxiliary additives are those compounds, which are capable of dissolving such lubricant oils, like mineral oils, alkylbenzene and polyalpholefin based synthetic oils. Furthermore, the auxiliary additive should not deteriorate thermodynamic functioning of the refrigerant and be low toxic. Among the substances, which fulfill the above requirements and are possible candidates for use as auxiliary additive are normal and isoparaffin hydrocarbons (e.g. n-pentane, n-hexane, pentane, i-hexane), cycloalkanes (e.g. cyclopentane, cyclohexane) and acetone. In the non limiting table 1 and 2 below are summarized substances, which could be used as an auxiliary additive in combination with methanol and ethanol respectively.

TABLE 1

| | Boiling point of | |
|---|---|---|
| Substance for use as | azeotrope mixture of | |
| auxiliary additive in | auxiliary additive with | Content of methanol |
| combination with | methanol at 760 mmHg, | within azeotrope mixture |
| methanol | in centigrades | in weight % |
| Acetone | 56 | 12 |
| Cyclopentane | 39 | 14 |
| Cyclohexane | 54 | 38 |
| n-Pentane | 31 | 7 |
| n-Hexane | 50 | 22 |
| i-Pentane | 25 | 4 |
| i-Hexane | 46 | 20 |

TABLE 2

| | Boiling point of | |
|---|---|---|
| Substance for use as | azeotrope mixture of | |
| auxiliary additive in | auxiliary additive with | Content of ethanol |
| combination with | ethanol at 760 mmHg, | within azeotrope mixture |
| methanol | in centigrades | in weight % |
| Cyclopentane | 45 | 8 |
| Cyclohexane | 65 | 31 |
| n-Pentane | 34 | 5 |
| n-Hexane | 58 | 21 |
| i-Pentane | 27 | 4 |
| i-Hexane | 52 | 12 |

One should bear in mind that by preventing the oil film formation on the inner surface of the tubes it is possible to improve the heat transfer irrespective whether the refrigerant is present in a system as a liquid or as a gas.

In view of the above, it is possible to reduce the volume of the system elements and at the same time to improve the efficiency of the whole system. Thus, when a heat exchange system employs refrigerants of the present invention, it should be less bulky and it should consume less refrigerant. This improvement can be achieved without compromising the system capacity. It can be readily appreciated that since the new refrigerants have reduced flammability they could be used in domestic systems on a larger scale and irrespective of the system size.

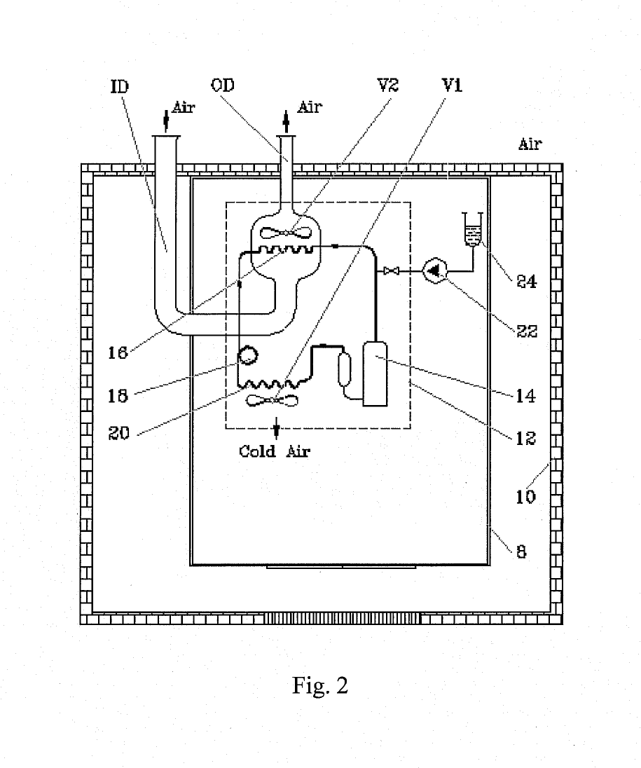

In practice the efficiency of the new refrigerants has been tested with the aim of a special experimental setup depicted in FIG. 2.

Referring now to FIG. 2, the experimental set up comprises a closed, thermally insulated chamber 8, which is arranged within a room 10. Within the chamber, is installed an air conditioner 12, which is in flow communication with the outside atmosphere due to an inlet duct ID and an outlet duct OD. The ambient air is forcibly taken by a first ventilator V1 within the air conditioner through the duct ID and duct OD. The cooled air flow is forced by a second ventilator V2. Within the air conditioner various necessary components are provided. Among those components are: a compressor 14, a condenser 16, a capillary 18, an evaporator 20, a dosing pump 22 and a receptacle 24.

The capillary or equivalent device is necessary for controlling difference of refrigerant pressure between condenser and evaporator. The receptacle and the dosing pump are necessary for controllable addition of an aliphatic alcohol to the refrigerant. In the present set up a portable air conditioner Pinguino PAC 46-ECO manufactured by DeLonghi was used. It is not shown in details but should be appreciated that the experimental set up also included the necessary instrumentation, like thermocouples, pressure regulators, manometers, flow meters etc.

During testing of the new refrigerants the following parameters were measured and monitored: air temperature within the chamber, air temperature at entrance to and exit from the condenser, air temperature at entrance to and exit from the evaporator, refrigerant temperature at critical points of the thermodynamic cycle, refrigerant pressure at entrance to and exit from the compressor, air flow through the evaporator and through the condenser, amounts of the aliphatic alcohol introduced in the circulation system, electric power consumed by the air conditioner. Current values of the above mentioned parameters were monitored and measured each second. In the following non-limited example are summarized results achieved with the above-described experimental set up. Operation of the air conditioner was monitored when it was filled with a conventional refrigerant, namely R290 and when it was filled with the refrigerant of the invention. The refrigerant of the invention consisted of azeotrope mixture of propane and methanol. For both situations in the circulation system of the air conditioner polyol ester based oil was used.

The achieved results in terms of cooling power, consumed power and coefficient of performance are summarized in the non-limited table 3 below. The cooling power and coefficient of performance were calculated as: cooling power, watts/consumed power, watts.

TABLE 3

| | | Refrigerant of the |
|---|---|---|
| Parameter | R290 | invention |
| Total refrigerant load, | 300 | 300 |
| grams | | |
| Propane | 300 | 290 |
| Methanol | 0 | 10 |
| Cooling power, watts | 1700 | 1800 |
| Consumed power, watts | 630 | 610 |
| Coefficient of | 2.7 | 3.0 |
| performance | | |

From the obtained results it is evident that the new refrigerant has improved properties related to the efficiency of the cooling system. Due to improved properties, it is possible to use the refrigerants of the invention in many domestic and industrial applications. The refrigerants of the invention can be used with different types of lubricants used in the existing cooling systems. It should be appreciated that the present invention is not limited by the above described embodiments and that one ordinarily skilled in the art can make changes and modifications without deviation from the scope of the invention as will be defined below in the appended claims. It should also be appreciated that features disclosed in the foregoing description, and/or in the foregoing drawings, and/or examples, and/or tables, and/or following claims both separately and in any combination thereof, be material for realizing the present invention in diverse forms thereof.

1. A refrigerant for use in a thermodynamic cycle of a system for producing either heat or cold, said refrigerant being a binary azeotrope mixture comprising of a saturated hydrocarbon having carbon chain with 2 or 3 atoms of carbon and an aliphatic alcohol selected from a group including methanol and ethanol.

2. The refrigerant as in claim 1, wherein said saturated hydrocarbon is selected from a group including propane and isobutane.

3. The refrigerant as in claim 2, wherein the azeotrope mixture is selected from a group including azeotrope mixture of propane with methanol, azeotrope mixture of isobutan with methanol and azeotrope mixture of propane with ethanol.

4. The refrigerant as in claim 3, wherein the content of aliphatic alcohol within the azeotrope mixture is 0.5-8.0 weight %.

5. The refrigerant as in claim 4, wherein the content of aliphatic alcohol within the azeotrope mixture of propane with methanol is 1.2-7.0 weight %.

6. The refrigerant as in claim 4, wherein the content of aliphatic alcohol within the azeotrope mixture of isobutane with methanol is 3.0-8.0 weight %.

7. The refrigerant as in claim 4, wherein the content of the aliphatic alcohol within the azeotrope mixture of isobutane with ethanol is 0.5-4.0 weight %.

8. The refrigerant as in claim 1, further comprising an additional component, said additional component being an auxiliary additive, selected from a group consisting of the following substances: acetone, cyclopentane, cyclohexane, n-pentane, n-hexane, i-pentane and i-hexane, wherein said additional component is capable to form binary azeotrope mixture with the aliphatic alcohol.

9. The refrigerant as in claim 8, wherein said binary azeotrope mixture comprises the auxiliary additive and methanol.

10. The refrigerant as in claim 8, wherein said binary azeotrope mixture consists of ethanol and of a substance selected from the group consisting of cyclopentane, cyclohexane, n-pentane, n-hexane, i-pentane and i-hexane.

11. The refrigerant as in claim 8, wherein amount of the aliphatic alcohol within the azeotrope mixture with the auxiliary additive is 4-38 weight %.
